(19) United States
(12) Patent Application Publication
(10) Pub. No.: US 2026/0361719 A1
(43) Pub. Date: Nov. 12, 2026

(54) METHOD AND SYSTEM FOR DECENTRALIZED AUTHENTICATION

(71) Applicant: Allthenticate, Inc., Houston, TX (US)

(72) Inventors: Chad SPENSKY, Houston, TX (US); Aniket BHOSALE, Houston, TX (US); Maria MATHEW, Houston, TX (US); Zeyu ZHANG, SINGAPORE (SG)

(73) Assignee: Allthenticate, Inc., Houston, TX (US)

(21) Appl. No.: 19/202,721

(22) Filed: May 8, 2025

(51) Int. Cl. H04L 9/40; G06F 21/62; H04L 9/08; H04L 9/32

(52) U.S. Cl. CPC H04L 63/0884; G06F 21/6245; H04L 9/085; H04L 9/321; H04L 9/3271

(57) ABSTRACT

Disclosed are systems and methods for decentralized credential recovery and authentication. A user device establishes a rescue team comprising a plurality of rescuer devices. A symmetric encryption key encrypting user credentials is split into unique key shares using a Shamir Secret Sharing (SSS) scheme requiring a threshold number for reconstruction, with shares distributed to respective rescuer devices. For recovery on a second user device, a process involves at least the threshold number of rescuer devices. Each involved rescuer device facilitates user verification via a challenge-response, with authenticity verified by the respective rescuer on the rescuer device. Verified rescuers transmit encrypted key shares to the second device, enabling symmetric key reconstruction and credential decryption. A backend server facilitates communication. The architecture also supports multi-factor authentication using the rescue team and threshold approval for authorizing user actions.

### GENERAL DESCRIPTION

This application relates to systems and methods for decentralized authentication and access control, particularly on mobile devices. While primarily focused on credential recovery, the underlying principles of the disclosed embodiments are broadly applicable to secure authentication and authorization processes. The disclosed embodiments address the problem of lost or inaccessible credentials due to device loss, malfunction, or forgotten passwords, but also can provide additional benefits related to enhancing the security and robustness of general authentication mechanisms.

Existing credential recovery methods often suffer from security vulnerabilities and usability issues. Traditional methods, such as password reset via email or security questions, are susceptible to phishing, social engineering, and account takeover. One-time pins (OTPs) delivered via SMS or email, while offering a second factor of authentication, are also vulnerable to interception through man-in-the-middle attacks, SIM swapping, or malware. Moreover, users often find these methods cumbersome and frustrating, leading to support requests and increased costs for businesses. These vulnerabilities and usability challenges also extend to conventional multi-factor authentication (MFA) systems, highlighting the need for more robust and user-centric security approaches.

Current cloud-based backup solutions offer some convenience for data recovery, but introduce privacy concerns and reliance on third-party providers. These solutions can be vulnerable to data breaches and service disruptions, and users may be hesitant to entrust their sensitive credentials to a centralized entity. Similarly, centralized authentication services can create single points of failure and vulnerability, impacting the overall security and resilience of systems relying on them.

Furthermore, existing methods, both for recovery and authentication, often fail to leverage the security capabilities of modern mobile devices. Features like the Trusted Execution Environment (TEE) offer a secure enclave for cryptographic operations, which can be used to enhance the security and trustworthiness of credential recovery processes and, more broadly, to strengthen user authentication mechanisms.

There is a need for a more secure, robust, user-friendly, and decentralized system that addresses both credential recovery and user authentication, leveraging the capabilities of mobile devices while minimizing reliance on external entities. The disclosed embodiments addresses this need by providing a novel approach based on social trust, distributed key management, and secure device-to-device communication, applicable to both credential recovery and general user authentication and authorization scenarios.

### BRIEF DESCRIPTION OF THE DRAWINGS

The features, aspects, and advantages of the invention will become apparent from the following description, and the accompanying exemplary embodiments shown in the drawings, which are briefly described below.

FIG. 1 is a simplified schematic of the recovery system architecture.

FIG. 2 is a simplified flow chart for initializing the recovery system.

FIG. 3 is a simplified flow chart for updating the recovery system.

FIG. 4 is a simplified flow chart for requesting the recovery process.

FIG. 5 is a simplified flow chart for recovering the data and/or credentials.

### DETAILED DESCRIPTION

According to one embodiment, a method for authentication of a user action is provided. The method comprises receiving an authentication request, where the authentication request is associated with a user action initiated via a user device. A pre-established authenticating team associated with the user is identified, this authenticating team comprising a plurality of rescuer devices, with each rescuer device being respective to an authenticating team member. A threshold number of the team members of the authenticating team is required for authentication approval, where this threshold number is less than or equal to a total number of team members within the authenticating team. An authorization request, related to the user action, is then transmitted to at least the threshold number of rescuer devices from the plurality of rescuer devices associated with the authenticating team. Each of the at least the threshold number of rescuer devices receives the authorization request. Subsequently, on the respective rescuer devices receiving the request, a verification step is performed by the respective authenticating team member to confirm the legitimacy of the user action. During this verification step, each respective rescuer device is configured to send verification approval data. The user device then receives approval signals, derived from the verification approval data, from a number of the respective rescuer devices equal to the threshold number. Finally, the approval signals are combined at the user device to perform the user action.

According to one embodiment, a system for recovering access to protected user data is provided. The system comprises a recovery computing device associated with a user. This recovery computing device is configured to initiate a recovery process that involves at least a threshold number of a plurality of rescuer computing devices, where these rescuer computing devices are associated with members of a pre-defined rescue team for the user. The recovery computing device is further configured to participate in a user verification protocol with the involved rescuer computing devices; this user verification protocol involves the recovery computing device receiving a challenge that requires a dynamic response from the user and subsequently generating and transmitting this dynamic response towards the respective rescuer computing devices. The recovery computing device is also configured to receive at least the threshold number of secured secret shares transmitted from different verifying rescuer computing devices. These secret shares correspond to a secret sharing scheme requiring the threshold number of shares for reconstruction of a cryptographic key, which is associated with protecting the user data. Furthermore, the recovery computing device processes the received secret shares to reconstruct the cryptographic key and utilizes the reconstructed cryptographic key to access the protected user data. The system also comprises the plurality of rescuer computing devices, each associated with a respective member of the pre-defined rescue team. Each rescuer computing device is configured to store one of the secret shares derived from the cryptographic key. Each rescuer computing device is also configured to participate in the user verification protocol initiated by the recovery computing device, which includes presenting the challenge requiring the dynamic response to the user via the recovery computing device, receiving the dynamic response from the user via the recovery computing device, and presenting the dynamic response to its associated rescue team member for assessment. Each rescuer computing device is further configured to receive an indication of successful user verification based on the assessment performed by its associated rescue team member. Responsive to this indication, the rescuer computing device transmits its stored secret share, secured for transit, towards the recovery computing device. Finally, the system includes an intermediary communication system configured to manage communication flow for the recovery process between the recovery computing device and the plurality of rescuer computing devices, including facilitating the user verification protocol involving the challenge and the dynamic response, and facilitating the transmission of the secured secret shares.

According to one embodiment, a method for recovering access to encrypted user credentials on a second user device is provided. The method involves establishing, by a first user device associated with a user, a rescue team comprising a plurality of rescuer devices, each associated with a trusted rescuer. The first user device generates a symmetric encryption key, which is used to encrypt the user credentials. Subsequently, the first user device splits the symmetric encryption key into a number of key shares using a Shamir Secret Sharing (SSS) scheme; this SSS scheme requires a first threshold number of shares for reconstruction, where the first threshold number is less than or equal to the number of rescuer devices within the plurality of rescuer devices. One unique key share, different from the other key shares, is securely distributed to each respective device of the plurality of rescuer devices. At a later time, a backend server receives a recovery request associated with the user from the second user device. The backend server then initiates a recovery process involving at least the first threshold number of rescuer devices from the established rescue team. During this process, each involved rescuer device generates a unique challenge for the user. The respective unique challenges are transmitted from the respective rescuer devices, via the backend server, to the second user device. Each involved rescuer device then receives, via the backend server, a challenge response from the second user device, this challenge response being associated with the respective unique challenge previously sent. Verification is performed by the respective rescuers on their respective rescuer devices, verifying the authenticity of the user based on the received challenge response. Responsive to successful verification, the respective rescuer devices encrypt their respective unique key shares using a public key associated with the second user device. These encrypted unique key shares are transmitted from the respective rescuer devices, via the backend server, to the second user device. The second user device receives at least the first threshold number of encrypted key shares originating from different verifying rescuer devices. The second user device then decrypts the received unique key shares. Using the decrypted unique key shares, numbering at least the first threshold number, the second user device reconstructs the symmetric encryption key. Finally, the second user device decrypts the user credentials using the reconstructed symmetric encryption key in order to recover data from the first user device to the second user device.

Upon initialization of the recovery and back-up system, the user's device generates three sets of cryptographic keys. First, an asymmetric key pair, consisting of a private key and a public key, is generated. This key pair is used for authentication and secure communication within the system. Second, a symmetric key is generated. This symmetric key is used to encrypt the user's credentials and is used to recover and decrypt the user's credentials that will be recovered in the future. The asymmetric and symmetric keys provide distinct but vital security within this system. Asymmetric keys handle secure control and authentication, establishing secure channels, verifying identities, and ensuring message integrity. The symmetric key utilized is for efficiently encrypting and decrypting the user's confidential credentials and backup data. This combination leverages asymmetric keys for secure management and symmetric keys for high-performance data protection, creating a balanced security architecture. Third, to ensure both the security and availability of the symmetric encryption key, Shamir's Secret Sharing (SSS) is employed. The encryption key is split into N shares, where N represents the total number of shares generated, using a threshold of X. This threshold signifies that any number X out of the N shares are sufficient to reconstruct the original encryption key, while fewer than X shares provide no information about the key. In this embodiment X may be 3 and N may be 5, meaning that the minimum number of trusted users in order to unlock the saved credentials are 3 out of 5. Each member of the user's rescue team receives one of these N shares, which are securely stored on their respective devices. This scheme ensures that at least three rescue team members must cooperate to reconstruct the encryption key and access the user's credentials, while also providing resilience against the unavailability of some team members or their devices.

A private key is a secret cryptographic key known only to the user and used in asymmetric encryption for authentication and digital signatures. A public key is the counterpart to the private key and can be shared publicly. It is used to verify digital signatures or encrypt messages that can only be decrypted with the corresponding private key. A symmetric key is a single secret key used for both encryption and decryption of data, offering efficient encryption of larger datasets. Shamir's Secret Sharing (SSS) is a cryptographic technique for splitting a secret into multiple shares, where a specified threshold of shares is required to reconstruct the original secret. Having a threshold less than the total number of shares provides redundancy, thus even if some shares are lost or unavailable, the secret can still be recovered if the threshold number of shares are available. In this context, SSS is used to distribute the symmetric encryption key among the rescue team members, ensuring that multiple members must cooperate for credential recovery while providing resilience against lost or unavailable shares.

The system allows initializing and/or adding a rescue team member and securely backing up user credentials. This process begins when the user requests the system to add a new team member by providing their email address. An email invitation is then sent to the prospective rescue team member, prompting them to join the rescue team. For rescue team members who are not already system users, the email includes instructions for application download and installation. Within the application, the rescue team member is prompted to either approve or deny the invitation. The user can then track the invitation status, such as “Not Delivered,” “Pending,” or “Accepted,” providing visibility into the team formation process. A secure list of rescue team member emails and unique identifiers is maintained on the backend server (i.e., the “backend”), which may include one or more processors, to facilitate later recovery, if needed. For redundancy, both the user and all rescue team members store copies of all encrypted key shares. This distributed storage ensures data availability even if a rescue team member requires their own credentials to be recovered. The system employs a secure update protocol for distributing encrypted key shares and essential identifying information to the rescue team. Specifically, this protocol encompasses: an invitation request initiated by the user's device to the backend; an invitation response from the rescue team member's device containing their information; subsequent transmission of encrypted backup data from the user's device to the rescue team member's device, including key shares and identifiers; an acknowledgement of receipt sent from the rescue team member's device; and the potential retrieval of a unique mission identifier to manage and track the recovery process. Alternatively, the system could utilize other secure communication methods beyond email for invitation and updates.

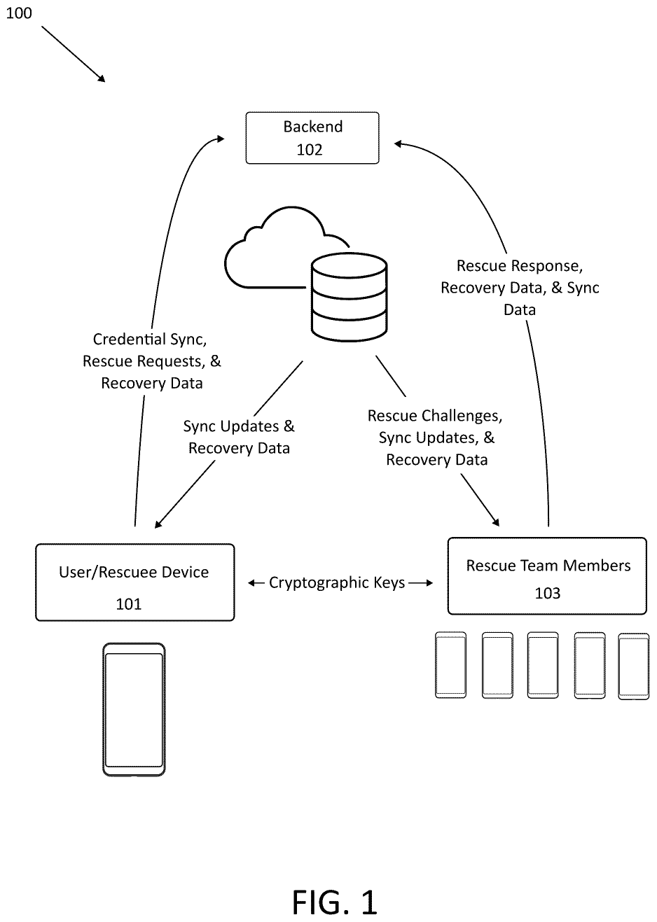

FIG. 1 presents a simplified system architecture of the recovery system 100 illustrating the core components and their interactions within the described credential recovery system. The diagram is centered around three primary entities: the user/rescuee device 101, the backend server or system 102, and the rescue team members 103. The rescue team members 103 may include two or more members. The rescue team members represent the distributed network of trusted individuals designated by the user 101 to assist in credential recovery. Rescue team members 103 are essential participants in the system's security model, providing local verification on their respective local devices, holding encrypted key shares necessary for the rescue mission process, and storing encrypted credential data. The backend 102 may include one or more database or servers to accommodate for the recovery system 100. The backend 102 manages communication flow, facilitates rescue team invitations, generates unique identifiers (e.g., Mission IDs) for rescue attempts, coordinates the initiation and progress of rescue missions, distributes challenges to rescuers, and securely relays associated encrypted data, including challenge responses from the user and encrypted key shares from the rescuers, between the relevant devices (101, 101a, 103).

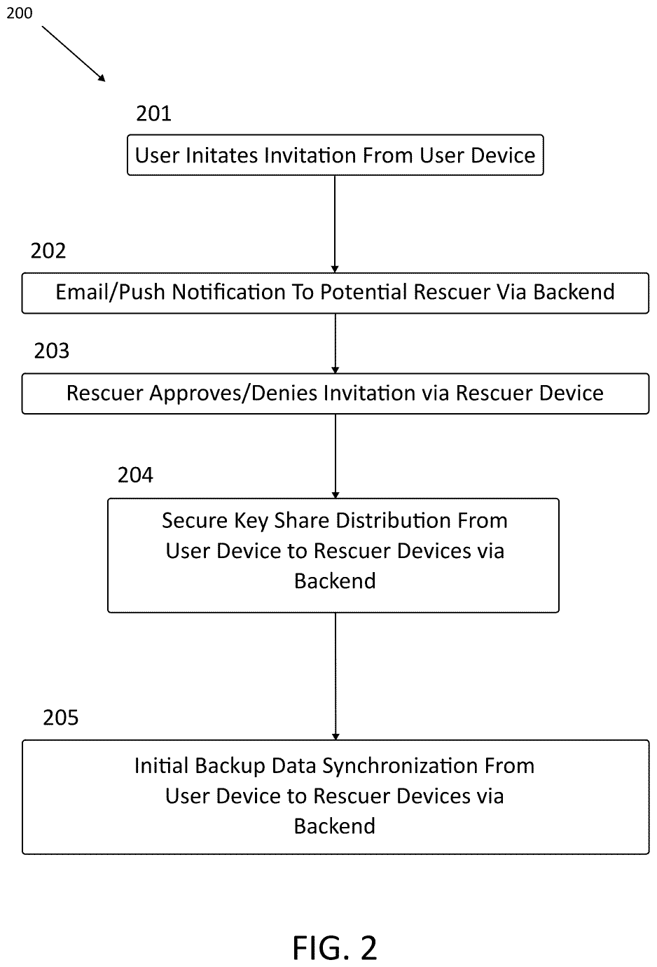

FIG. 2 illustrates a process flow diagram 200 detailing the Rescue Team invitation and setup procedure. The process initiates at step 201, where the user, utilizing their user device, begins the invitation process to add a new rescue team member. Step 202 depicts the system sending an invitation to the potential rescuer via the backend, typically using email or a push notification. At step 203, the potential rescuer receives the invitation and responds by either approving or denying the request through their rescuer device. Upon acceptance of the invitation, the system proceeds to step 204, where secure key share distribution occurs. In this step, the user device securely transmits the encrypted key shares to the rescuer devices, facilitated by the backend system. Alternatively, the secure key (and/or any other cryptographic keys utilized by the system) may be directly sent over from device to device directly without the use of the backend. Finally, step 205 illustrates the initial backup data synchronization, wherein the user device transmits the encrypted backup data to the rescuer devices, again utilizing the backend for efficient and reliable distribution. This process flow outlines the essential steps for establishing a rescue team and securely distributing the necessary cryptographic components and backup data to the designated rescue team members.

The invitation flow for adding a new member to the rescue team involves several states for the potential rescue team member, allowing the user to track the progress of the invitation and manage their rescue team effectively. These states provide a structured approach to team management and ensure a clear understanding of each potential member's status. The “Invited” state indicates that an email invitation has been sent to the potential rescue team member, but they have not yet signed up for the rescue system. This state persists until the potential rescue team member creates an account. The user will see this status if the provided email address was not already associated with a system user. Once the potential rescue team member creates an account, their state transitions to “Pending.” This state signifies that the invitation is awaiting their response. They have received the invitation but have not yet accepted or denied it. The user will see this status while the rescue team member is considering the invitation. If the potential rescue team member accepts the invitation, their state changes to “Accepted.” They are now officially a member of the rescue team, and their device will begin receiving encrypted backups of the user's credentials. This is the desired state for active rescue team members. Conversely, if the potential rescue team member declines the invitation, their state becomes “Denied.” They will not be added to the rescue team and will not receive any backups. The user can then choose to invite a different individual. This state allows the user to manage their team and ensures that only willing participants are included.

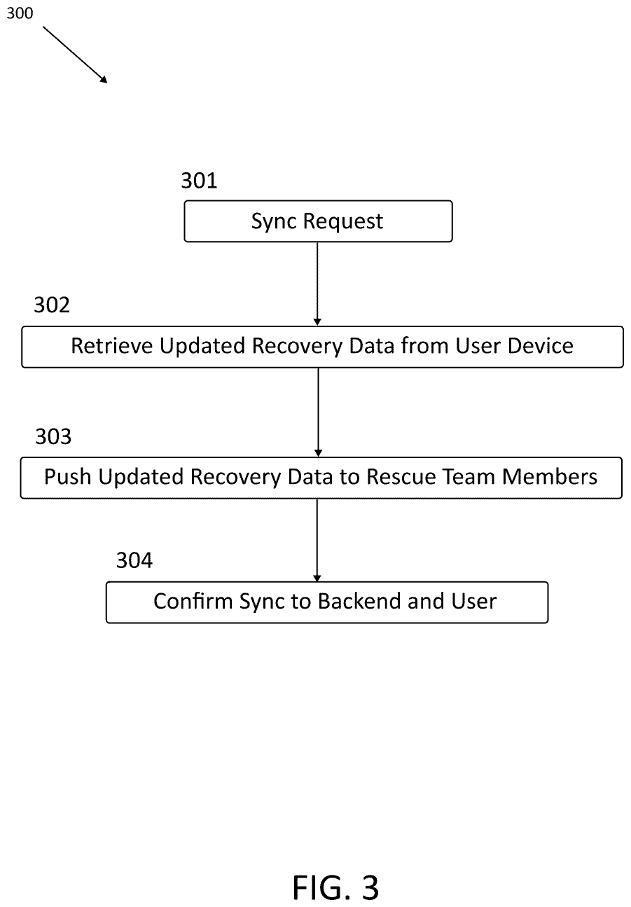

FIG. 3 illustrates a process flow diagram 300 outlining the data synchronization protocol employed to maintain consistency of the rescue data across the system. The synchronization process for updated rescue data, as depicted in aspects of FIG. 3, commences when the user device detects a change in its rescue data and initiates a sync by sending the updated data to the backend system. This sync request, at step 301, may be done periodically and automatically and the backend system may also initiate periodic sync checks. Following the initiation of the synchronization request, step 302 involves retrieving the updated recovery data (i.e. credentials) from the user device, indicating that the user device is the source of the latest data. Subsequently, at step 303, the backend system takes the retrieved updated recovery data and pushes it out to all designated rescue team members' devices, ensuring that each member receives the most current information. The final step, 304, depicts the confirmation of synchronization. In this step, each rescue team member device, upon successfully synchronizing its local data, sends a “Confirm Sync” message back to the backend, and the backend, in turn, may relay a confirmation of the completed synchronization back to the user device, completing the data update and consistency maintenance process.

To ensure that the rescue team members possess the most current backup information, a data synchronization process is implemented to propagate any modifications to the rescue data. This synchronization is essential whenever the user adds, removes, or modifies keys or other critical data within their rescue data.

When the user initiates an update to their rescue data, their device sends an “Update” message to the backend system. This message includes the encrypted backup data, digitally signed by the user to ensure authenticity and integrity, and specifies the intended recipient rescue team member. The backend system, upon receiving this message, acknowledges receipt to the user's device, indicating that the update has been successfully sent or queued for delivery. In scenarios where a rescue team member's device is temporarily offline, the backend system intelligently caches the update, holding it in temporary storage until the rescue team member's device reconnects and becomes available to receive the update.

Once the rescue team member's device is online, the backend system pushes the “Update” message to the rescue team member. This message again includes the encrypted backup data, digitally signed by the user, along with a transaction identifier to track the update process. Upon receiving the update and successfully synchronizing their local copy of the rescue data, the rescue team member's device sends a “Synced” message back to the backend. This “Synced” message, digitally signed by the rescue team member, includes a cryptographic hash of the encrypted backup data, providing a further verification of data integrity and successful synchronization. The backend system, upon receiving the “Synced” message from the rescue team member, again acknowledges receipt and then forwards a “Synced” message to the user's device, confirming to the user that the update has been successfully propagated to that particular rescue team member. Similar to the initial update message, the backend system also employs caching for “Synced” messages, ensuring reliable delivery even if the user's device is temporarily offline.

To maintain data consistency and ensure that all rescue team members possess the latest version of the backup data, the backend system retains only the most recent update data for each user while a transaction is active. This ensures that if a rescue team member's device has been offline for an extended period and missed previous updates, it will retrieve the absolute latest version when it reconnects. If a new update transaction is initiated by the user, any previous, ongoing transactions are automatically canceled, and the backend begins tracking the new update, ensuring that the rescue team always converges on the most current rescue data.

To manage data versioning and prevent outdated data from being accepted, a versioning system is utilized. In a preferred embodiment, this involves a simple increasing of the version number. Each update to the rescue data is assigned a new version number, which is numerically greater than the version number of the preceding data state. When a rescue team member's device receives an update message, it compares the incoming version number with the version number of its currently stored local copy of the backup data. An update message is accepted and processed only if its version number is greater than the local version number, thereby preventing the introduction of older or stale data into the system and ensuring chronological consistency. If a rescue team member's device receives an update message with a version number that is less than or equal to its own current version number, the update message is rejected. While this straightforward versioning system is effective for many implementations, alternative timestamping or versioning mechanisms, such as logical clocks (e.g., Lamport clocks), could also be employed to achieve similar data consistency guarantees, particularly in more complex distributed scenarios.

The data transmitted and stored within the system is structured in a defined format to facilitate efficient processing and secure storage. This structured format comprises a collection of encrypted data elements essential for backup and recovery. These elements are organized and encoded to ensure secure transmission and efficient storage across the distributed system. The structured format ensures that all necessary information for backup and subsequent recovery is transmitted and stored in a well-defined and organized manner, enabling reliable and efficient operation of the credential recovery system. The specific format of the data elements may vary depending on the implementation and the types of data being backed up.

The backend system plays a central role in managing the data synchronization and transaction flow. The backend maintains a record of active transaction identifiers, ensuring that only one update transaction is active at a time for a given user. For each user, the backend stores the latest transaction identifier and the associated rescue data. The backend also maintains a list of pending rescue updates for each rescue team member, enabling efficient push delivery when rescue team member devices come online. The backend provides functionalities such as generating unique transaction identifiers, initiating and managing user updates to the rescue team, retrieving pending rescue updates for rescue team members, and recording when a rescue team member has successfully completed data synchronization. These backend functions ensure the reliable and consistent distribution of updated rescue data across the rescue team. Updates are referenced by cryptographic hashes, and only the most recent update is persistently stored on the backend for reference and recovery purposes, optimizing storage and maintaining data integrity. In alternative embodiments, some or all of these backend functionalities could be distributed across user and rescue team member devices to further decentralize the system.

Modifying the rescue team to delete a member triggers a process to ensure continued security and proper key management. When a user decides to remove a member from their rescue team, several actions are initiated. First, the system notifies the deleted member of their removal from the rescue team. Subsequently, the user's device automatically generates a new set of Shamir Secret Sharing (SSS) key shares. This key regeneration is crucial to maintain the security of the credential recovery system, as the removed member no longer should possess a valid share of the encryption key.

Following key regeneration, the system initiates a key redistribution process. The newly generated SSS key shares are securely distributed to the remaining active members of the rescue team. This redistribution ensures that only the current, authorized rescue team members possess valid key shares for future credential recovery. It is important to note that after removing a member and redistributing keys, the total number of distributed shares will be reduced. In scenarios where the original number of rescue team members was only slightly above the threshold for key recovery, deleting a member may result in the number of active shares being closer to, or even equal to, the threshold.

To accommodate potential future additions to the rescue team, the system reserves a set of newly generated key shares during this process. These reserved shares are not immediately distributed but are held in secure storage, ready for distribution to any new rescue team members the user may add in the future. This key reservation mechanism provides flexibility and scalability, allowing the user to modify their rescue team membership over time without compromising the security or functionality of the credential recovery system. By generating new keys, redistributing to remaining members, and reserving keys for future members, the system ensures that the security of the user's credentials remains robust even as their rescue team composition changes.

The system also incorporates a mechanism to handle the scenario where a rescue team member obtains a new device, such as a new phone. In such cases, when a rescue team member successfully authenticates their account or completes a device setup process on a new device, a device change event is triggered within the system, and the user (original rescuee) is promptly notified of this event. This notification alerts the user to the fact that a rescue team member is now operating from a new device and that security procedures are being initiated.

Upon notification of a rescue team member's new device confirmation, the system automatically initiates a key regeneration process. Crucially, this process involves generating a completely new set of Shamir Secret Sharing (SSS) keys for the entire rescue team, not just for the member with the new device. This comprehensive rekeying is a vital security measure. Once the new keys are generated, they are securely redistributed to all active members of the rescue team, ensuring that everyone is operating with the latest cryptographic keys.

Following the successful redistribution of the new SSS keys to all active rescue team members, the system mandates the deletion of the old SSS keys. This deletion is paramount for security. It mitigates potential risks associated with the old device, which may no longer be under the rescue team member's control and could potentially be compromised by an attacker. By invalidating and deleting the old keys, the system effectively limits the window of opportunity for an attacker who might have gained access to a key share on the previous device.

In the event that a rescue team member requires access to their encrypted data and keys on their new device (i.e., they are effectively “rescuing themselves” by setting up the application on a new phone), they can retrieve this information from several potential sources. While the backend system serves as the primary and most reliable source for retrieving encrypted data and keys, alternative retrieval paths are also available for redundancy. A rescue team member could, in principle, obtain the necessary encrypted data and keys from the original user (rescuee) or from other members of the rescue team. However, in typical operation, the backend system will be the primary point of contact for retrieving this information, resorting to communication with other members only if cached data is unavailable or invalid.

Furthermore, the backend system assumes responsibility for proactively notifying the user when a rescue team member has successfully completed the device migration and data recovery process on their new device. This notification serves as a critical prompt to the user, indicating that while the rescue team member has regained access, it is highly recommended that the user initiate a rekeying procedure. This rekeying, as described above, generates and distributes entirely new keys, assuring forward secrecy for any newly added private data and further bolstering the overall security posture of the credential recovery system in light of the device change event.

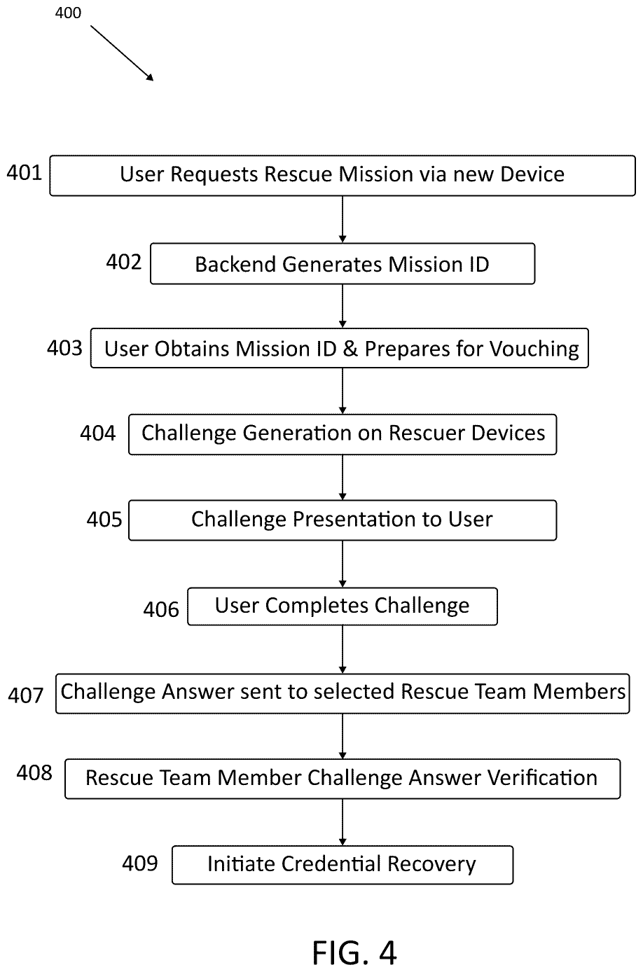

FIG. 4 presents a process flow diagram 400 illustrating the Rescue Mission initiation and execution sequence for credential recovery. The process commences at step 401, where the user, utilizing a new device, initiates a Rescue Mission, signaling their need to recover access to their credentials. Subsequently, at step 402, the backend system generates a unique Mission ID, providing a specific identifier for this particular recovery attempt, facilitating tracking and management of the process. Step 403 then involves the user being instructed to share this Mission ID with one or more members of their pre-established rescue team to obtain a ‘vouch’ for the mission. This vouching step, detailed further below, is a key part of authorizing the rescue before proceeding to challenge generation. Following successful vouching and subsequent user choices or system flows, step 404 illustrates the automated challenge generation process occurring on the designated rescue team members' devices, preparing unique verification prompts. Step 405 shows the presentation of these generated challenges to the user on their new device, prompting them to undertake the necessary verification actions. At step 406, the user completes the presented challenge, generating a response, such as recording a verification video. This challenge response, as depicted in step 407, is then securely transmitted and distributed to the selected rescue team members for their review and assessment. Step 408 illustrates the Rescue Team Member Challenge Answer Verification process, wherein each rescue team member evaluates the user's response to confirm their identity and challenge completion. Finally, at step 409, upon successful verification by a sufficient number of rescue team members, the system initiates the credential recovery process, allowing the user to regain access to their protected credentials on the new device.

In the event that a user obtains a new device, such as replacing a lost or malfunctioning phone, a “Rescue Mission” is initiated to restore access to their credentials on the new device. Upon starting a Rescue Mission, the user may be presented with an educational screen. This screen explains the steps involved in the rescue process, clarifies the user's role, and outlines what to expect during the mission. After acknowledging this information, the system generates a unique mission ID, which serves to identify and track this specific recovery attempt.

For the duration of the rescue mission, the user's new device generates and utilizes a temporary private key. This temporary key is essential for establishing secure communication channels and protecting data transmitted during the recovery process. This temporary key pair may be validated by the recovery system via the ability of the new device to access the rescuee's email account and/or the vouching of the new device from other rescue team members. The user is then presented with two primary options to initiate the Rescue Mission: either by clicking a secure link provided in a previously sent email, or by directly contacting members of their rescue team to request a “vouch” for their identity.

If the user chooses the “vouch” method, they must communicate the generated mission ID to their rescue team members through an out-of-band channel (e.g., verbally, secure messaging). Each rescue team member then enters this mission ID into their respective application to initiate their participation in the rescue process.

The user is then prompted to authenticate themselves on the new device to access the list of their rescue team members stored on the backend system. One authentication method available is PIN-based decryption. This PIN is initialized and set by the user during setup of the user's device to the recovery system. The user is given a limited number of PIN entry attempts, for example, three attempts. If the PIN is entered correctly within the allowed attempts, the list of rescue team members, encrypted using the PIN, is decrypted. This decryption process is performed securely on the backend servers, using a known-good PIN-derived value for verification purposes, enhancing security by preventing brute-force attempts on the device itself. Successful decryption verifies the PIN and retrieves the rescue team list. Failed PIN attempts are logged by the system, and the user's previous device (if still active and connected) is notified of these failed attempts, providing an alert against potential unauthorized recovery attempts. If the PIN-based decryption is unsuccessful after the allowed attempts, the backup data associated with the PIN-protected rescue team list is securely deleted from the backend to prevent further unauthorized access via this method.

If the vouching process is utilized and a rescue team member successfully vouches for the mission, the system may directly identify the rescue team, and the user may not need to perform PIN-based decryption of their rescuer list or manually enter rescuer email addresses. However, if vouching is not immediately available, or if the user needs to identify their rescue team members to request a vouch, they may be prompted to authenticate on the new device to access their list of rescue team members. If PIN-based decryption for this list fails or is not used, the user can then manually enter the email addresses of their rescue team members directly into the application on the new device. It is important to note that the application user interface does not provide any immediate validation of these entered email addresses at this stage. Once the user has entered a sufficient number of email addresses, for example, at least three, they are presented with the option to “Request to be Rescued.” Upon selecting this option, the user is informed that if the entered email addresses are valid and the corresponding rescue team members are available, a verification challenge will be initiated for each of them.

In the background, upon the user initiating the rescue request, the application on each rescue team member's device automatically generates a unique, random challenge to be presented to the user seeking recovery. This challenge could take the form of, for instance, a short video. The user, upon selecting “Challenge Accepted,” is prompted to record a short video, for example, a five-second video, reciting the specific challenge presented to them, such as “Say the number 123.” This recorded video is then digitally signed using the temporary private key generated on the user's new device, providing cryptographic verification of the video's authenticity and origin. For maximum security this challenge may be human-generated instead of automatically generated, and even be interactive. Alternative embodiments may employ human-generated or interactive challenges to further increase security against sophisticated attacks, such as pre-recorded responses or edited videos. In a human-generated challenge scenario, instead of the rescuer's device automatically generating a random prompt, the rescuer's application could present an interface allowing the rescuer to manually input a unique challenge for the user. This could involve asking the user to state a specific, unpredictable phrase, perform a particular gesture, or answer a question that relies on shared context or recent interaction. The unpredictability introduced by human input makes it significantly harder for an attacker to anticipate and prepare a fraudulent response. Furthermore, an interactive challenge could involve a brief, securely mediated real-time interaction between the user and the rescuer via their respective devices. For example, the system could facilitate a short, encrypted video call snippet where the rescuer dynamically asks the user to perform an action or respond to a question live. Alternatively, during the user's video recording, the rescuer may push a dynamic instruction (e.g., “Now hold up today's newspaper headline”) that the user must comply with in real-time within the recording. Such interactive methods provide strong liveness detection and make spoofing extremely difficult. While potentially requiring more synchronous availability or active participation from the rescuer compared to fully automated challenges, these human-centric approaches offer a significantly heightened level of assurance, particularly valuable in high-security contexts or when dealing with potentially compromised accounts.

Each designated rescue team member then receives a rescue request within their application. This request includes the video recorded by the user and the specific challenge prompt that was presented to them. The rescue team member is then prompted to verify if the video is indeed of the correct person and if the challenge has been satisfied correctly. If the rescue team member successfully verifies the user's identity and challenge response, they select “Rescue!” within their application. Upon selecting “Rescue!”, the rescue team member's application encrypts their respective Shamir Secret Sharing (SSS) key share and the user's encrypted rescue data using the temporary public key of the user's new device. This encrypted information is then securely transmitted back to the user's new device. Beyond video challenges, alternative challenges contemplated by one of ordinary skill in the art could include, but are not limited to, audio recordings, dynamic text-based challenges requiring real-time response, or interactive graphical challenges.

Once the user's new device has received and verified responses from a sufficient threshold number of rescue team members (e.g., three out of five), the system proceeds with credential recovery. The received, encrypted SSS key shares are decrypted and combined to reconstruct the original symmetric encryption key. This reconstructed key is then used to decrypt all of the user's backed-up credentials and rescue data. At this point, the new device effectively becomes the user's primary, “old” device within the system, now possessing full access to the user's credentials. A success notification, digitally signed using the newly recovered private key, is automatically transmitted to the backend system, confirming the successful Rescue Mission completion. Furthermore, a separate command, also digitally signed with the recovered private key, is sent to the user's previous device, instructing it to initiate a secure data wipe, further enhancing security by removing sensitive data from the potentially compromised old device.

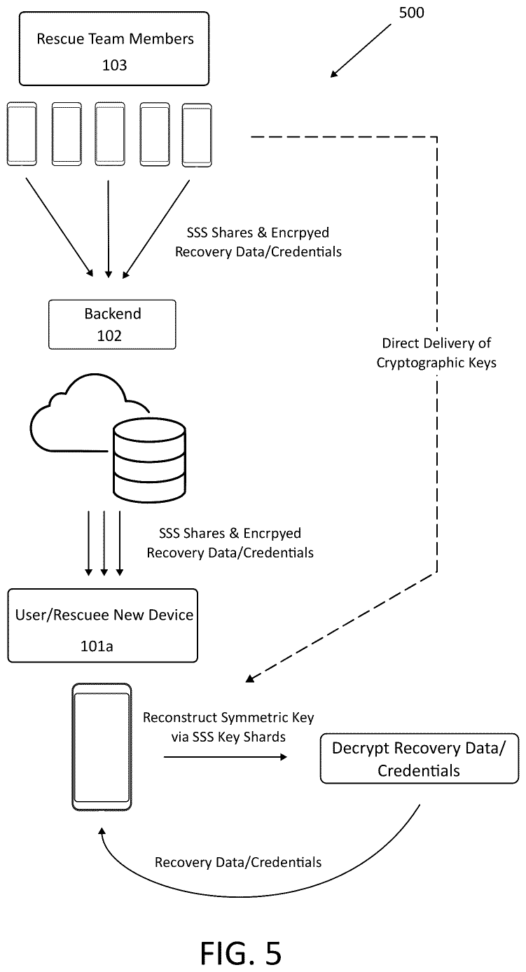

FIG. 5 illustrates a data flow diagram 500 depicting the credential recovery process initiated after successful challenge verification by the rescue team members. The diagram highlights the central role of the rescue team members 103 in providing the necessary components for recovery. As shown, the rescue team members 103 transmit “SSS Shares & Encrypted Recovery Data/Credentials” towards the backend 102) This transmission represents the secure relaying of the encrypted Shamir Secret Sharing SSS) key shares and the encrypted recovery data from each verifying rescue team member to the backend system. The Backend (102), acting as an intermediary, then forwards these “SSS Shares & Encrypted Recovery Data/Credentials” to the user new device 101a. Upon receiving the threshold number of encrypted SSS shares and the encrypted recovery data, the user new device 101a performs two key operations: “Reconstruct Symmetric Key via SSS Key Shards” and “Decrypt Recovery Data/Credentials”. The user device combines the received SSS key shares to mathematically reconstruct the original symmetric encryption key. Subsequently, the user device decrypts the encrypted backup data using the reconstructed symmetric key, resulting in the recovered data or credentials being accessible on the new user device 101a, thereby completing the Rescue Mission.

To enhance security and user control, once a Rescue Mission is initiated, the user's previous device (if still active and online) receives a notification alerting them to the ongoing rescue process. The user of the previous device is provided with the ability to halt the Rescue Mission if they believe it to be unauthorized or fraudulent. If the Rescue Mission is stopped via the previous device, all ongoing rescue attempts are immediately halted for that user's account for a predetermined period, for example, X days, to prevent further unauthorized recovery attempts and allow the legitimate user to secure their account. It is also noted that while the user's private keys are successfully recovered and restored to the new device, the new device will inherently possess a different device-specific unique identifier (UUID) within the system compared to the previous device. This device UUID change is recorded and managed by the system to maintain accurate device tracking and security auditing.

The configuration of Shamir's Secret Sharing (SSS) within the rescue system allows for adjustment of the balance between security, redundancy, and user convenience through the selection of the threshold and the total number of shares distributed to rescue team members. For example, a “3-out-of-5” configuration, as utilized in the described embodiment above, signifies that the encryption key is split into five shares, but only any three of these shares are required to reconstruct the original key and recover user credentials. This configuration provides a degree of redundancy, allowing for up to two rescue team members to be unavailable or unresponsive during a recovery operation without hindering the user's ability to regain access. In contrast, a “4-out-of-5” configuration would increase the threshold to four shares, requiring the cooperation of at least four out of the five rescue team members for successful recovery. This configuration offers reduced redundancy, tolerating only a single unavailable member, but may be perceived as providing a marginally increased level of security against compromise as more shares are needed for unauthorized reconstruction. At the extreme end of the spectrum, a “5-out-of-5” configuration represents a scenario where all five shares are mandatory for key reconstruction. While offering the theoretical highest level of security against share compromise within this specific team structure, a 5 -out-of-5 configuration provides no redundancy; the unavailability of even a single rescue team member would render credential recovery impossible. Therefore, the optimal configuration for the SSS threshold and share count is a design choice that depends on the desired balance between robust recoverability, user convenience, and the acceptable level of risk tolerance for potential share compromise. Lower thresholds, like 3-out-of-5, prioritize user convenience and system resilience, while higher thresholds, approaching N-out-of-N, emphasize a potentially increase in security at the cost of reduced fault tolerance and increased user coordination requirements during a recovery mission, which can be utilized for highly secure environments where data confidentiality and security is the priority.

The system employs a distributed storage model, with different types of data and cryptographic keys stored on the user's device (rescuee) and the rescue team members' devices (rescuers), optimized for security and efficient operation.

On the user's device, or rescuee device, several key data elements are securely stored. These include the asymmetric private key, crucial for authentication and digital signatures within the system, and the symmetric encryption key, which is employed to encrypt the user's comprehensive backup data. Furthermore, the N Shamir secrets are generated from the symmetric key. For each rescue team member, a copy of the Shamir secret assigned to that member is securely stored on the user's device, encrypted using the respective rescue team member's public key. Once a share is encrypted and associated with a specific rescue team member, the corresponding unencrypted version of that share is removed from the user's local storage. This encrypted share is stored in association with the rescue team member's public key and unique identifier and is treated as part of the backup data configuration maintained by the user; this allows the encrypted share to be resent to the rescue team member should they need it again, for instance, if they acquire a new device. Finally, the user's comprehensive backup data, encompassing credentials and other sensitive information, is also stored locally on the user's device, encrypted using the symmetric encryption key.

On the rescue team member's device, or rescuer device, a distinct set of data elements is securely stored. This includes a copy of the user's (rescuee's) main backup data, encrypted with the user's symmetric encryption key. The rescuer device also stores its individually assigned Shamir secret (share), which may be protected by encryption methods local to the rescuer's device or application security. This share is associated with the user's (rescuee's) unique identifier and the rescuer's index within the rescue team. To ensure the secrecy of the rescuer's participation and their assigned share index, the user's unique identifier and the rescuer's index may be treated as sensitive information and stored securely, potentially included within the encrypted backup data structure maintained on the rescuer's device. Crucially, during a rescue mission, when the rescuer approves the recovery request, their device encrypts their stored Shamir secret share using the public key provided by the user's (rescuee's) new device (specifically, the public key generated for that rescue mission) before transmitting it. This ensures the confidentiality of the share during transit to the user requesting recovery.

To maintain the integrity and reliability of the credential recovery system, the backend system actively monitors the “health” of each user's rescue team. This health monitoring encompasses several key aspects: Last Seen Online Tracking, where the system tracks the last time each rescue team member's application was seen online and actively communicating with the backend to provide an indication of their availability and responsiveness; Data Synchronization Monitoring, where the system continuously verifies that all rescue team members possess the latest, synchronized backup data to ensure data availability during recovery; and Key Data Management, where the system automatically manages the deletion of old key data and the secure distribution of new keys upon team modifications or device changes. These proactive health monitoring and key management functions contribute to the long-term robustness and security of the distributed credential recovery system.

In conclusion, the described credential recovery system presents a novel and advantageous approach to securing and recovering user credentials, particularly in the mobile environment. By leveraging a decentralized architecture, social trust through a user-defined rescue team, and robust cryptographic techniques such as Shamir's Secret Sharing and hardware-backed key storage, the system achieves a compelling balance of security, user convenience, and resilience. The Rescue Mission protocol, incorporating challenge-response verification and threshold-based recovery, offers a secure and intuitive method for users to regain access to their credentials even in device loss scenarios. Furthermore, the proactive data synchronization and rescue team health monitoring mechanisms ensure data consistency and long-term reliability. This innovative system overcomes the limitations of traditional password recovery methods and centralized cloud-based solutions, providing a significantly enhanced user experience and a more robust security posture for managing and recovering sensitive digital credentials in an increasingly mobile and interconnected world.

Beyond credential recovery, this system's underlying architecture can be adapted to provide a highly secure and distributed multi-factor authentication mechanism for user logins and access control, leveraging the same rescue team verification and cryptographic protocols. Such authentication could potentially interact with or secure access to user-controlled crypto wallets, leveraging the system's decentralized trust model. The described credential recovery system offers a compelling and potentially more robust approach when adapted for user authorization compared to conventional two-factor or multi-factor authentication methods. Instead of relying on easily phishable one-time codes or potentially losable hardware tokens, this system leverages a decentralized network of trusted individuals and cryptographically secured challenge-response mechanisms to authorize user access. This inherently distributed nature eliminates single points of failure common in traditional 2FA implementations, enhancing resilience against targeted attacks and service disruptions. Furthermore, the incorporation of social trust and human verification within the authorization process introduces a layer of security that is significantly harder to subvert than automated or purely technical 2FA methods. By shifting the authorization paradigm towards a socially-verified, cryptographically enforced model, this technology presents a pathway to a more secure, user-centric, and robust multi-factor authorization framework, moving beyond the limitations of conventional 2FA while retaining or enhancing its core security benefits.

It is a key aspect of this system that the roles of “rescuee” and “rescuer” are not mutually exclusive as any user within the system can function in both capacities. A user, initially setting up a rescue team to protect their own credentials, can simultaneously serve as a rescue team member for other users within their trusted network. This reciprocal arrangement creates an interconnected web of trust, where any member of a rescue team can potentially initiate a Rescue Mission to recover their own credentials, relying on the assistance of other team members. This network not only reinforces the robustness of the system by distributing recovery responsibilities but also underscores the collaborative and socially-driven nature of the credential security framework, ensuring that any member of the user community can benefit from, and contribute to, the collective security provided by the distributed rescue network.

Throughout this specification, the terms “user” and “rescuee” are used interchangeably to refer to the individual who utilizes the credential recovery system and establishes a rescue team. Similarly, the terms “rescue team member” and “rescuer” are used synonymously to denote the trusted individuals who are invited to join a user's rescue team and assist in the credential recovery process. The term “credentials” and “recovery data” is also used interchangeably as different types of data can be saved/backed up and restored. Similarly, “rescue mission” or “data recovery” may be used interchangeably within this disclosure.

It is noted that the foregoing examples have been provided merely for the purpose of explanation and are in no way to be construed as limiting of implementations of the present invention. While aspects of the present invention have been described with reference to an exemplary embodiment, it is understood that the words which have been used herein are words of description and illustration, rather than words of limitation. Changes may be made, within the purview of the appended claims, as presently stated and as amended, without departing from the scope and spirit of the present disclosure in its aspects. Although implementations of the present invention have been described herein with reference to particular means, materials and embodiments, implementations disclosed herein are not intended to be limited to the particulars disclosed herein; rather, implementations of the present invention extend to all functionally equivalent structures, methods and uses, such as are within the scope of the appended claims.

What is claimed:

1. A method for authentication of a user action, comprising:
receiving an authentication request associated with a user action initiated via a user device;
identifying a pre-established authenticating team associated with the user, the authenticating team comprising a plurality of rescuer devices respective with each authenticating team member, wherein a threshold number of the team members of the authenticating team is required for authentication approval, where the threshold number is less than or equal to a total number of team members of the authenticating team;
transmitting an authorization request related to the user action to at least the threshold number of rescuer devices of the plurality of rescuer devices associated with the authenticating team;
receiving, at each of the at least the threshold number of rescuer devices, the authorization request;
performing, on respective rescuer devices of the at least the threshold number of rescuer devices, a verification step by the respective authenticating team member to confirm the legitimacy of the user action on the respective rescuer devices;
wherein each respective rescuer device of the verification step is configured to send verification approval data from the respective rescuer devices;
receiving, via the user device, approval signals from the respective rescuer devices equal to the threshold number; and
combining the approval signals to perform the user action on the user device.

2. The method of claim 1, wherein performing the verification step comprises presenting details of the user action to the respective authenticating team member on the respective rescuer device for review and confirmation.

3. The method of claim 1, wherein performing the verification step further comprises initiating a challenge-response interaction between the respective rescuer device and the user device, requiring the user to provide a response via the user device that is assessed by the authenticating team member on the respective rescuer device.

4. The method of claim 1, wherein the user action relates to authorizing access to or a transaction involving a user-controlled crypto wallet.

5. The method of claim 1, wherein the pre-established authenticating team is identical to a authenticating team previously established by the user for credential recovery purposes.

6. The method of claim 1, wherein the verification approval data configured to be sent from the respective rescuer devices is digitally signed using a private key associated with the respective rescuer device.

7. A system for recovering access to protected user data, comprising:
a recovery computing device associated with a user, configured to:
initiate a recovery process involving at least a threshold number of a plurality of rescuer computing devices associated with members of a pre-defined rescue team for the user;
participate in a user verification protocol with the involved rescuer computing devices, wherein the user verification protocol involves receiving a challenge requiring a dynamic response from the user and subsequently generating and transmitting the dynamic response towards the respective rescuer computing devices;
receive at least the threshold number of secured secret shares transmitted from different verifying rescuer computing devices, wherein the secret shares correspond to a secret sharing scheme requiring the threshold number of shares for reconstruction of a cryptographic key associated with protecting the user data;
process the received secret shares to reconstruct the cryptographic key; and
utilize the reconstructed cryptographic key to access the protected user data;
the plurality of rescuer computing devices, each associated with a respective member of the pre-defined rescue team, each rescuer computing device configured to:
store one of the secret shares derived from the cryptographic key;
participate in the user verification protocol initiated by the recovery computing device, including presenting the challenge requiring the dynamic response to the user via the recovery computing device;
receive the dynamic response from the user via the recovery computing device;
present the dynamic response to its associated rescue team member for assessment;
receive an indication of successful user verification based on the assessment by its associated rescue team member; and
responsive to the indication of successful user verification, transmit its stored secret share, secured for transit, towards the recovery computing device; and
an intermediary communication system configured to:
manage communication flow for the recovery process between the recovery computing device and the plurality of rescuer computing devices, including facilitating the user verification protocol involving the challenge and the dynamic response, and facilitating the transmission of the secured secret shares.

8. The system of claim 7, wherein the rescuer computing device being configured to transmit its stored secret share, secured for transit, comprises being configured to encrypt the secret share using a public key associated with the recovery computing device.

9. The system of claim 7, wherein the dynamic response comprises a video recording generated by the user via the recovery computing device, and wherein the rescuer computing device is configured to display the video recording to its associated rescue team member for the assessment.

10. The system of claim 7, wherein the rescuer computing device being configured to participate in the user verification protocol includes being configured to receive input from its associated rescue team member defining the challenge presented to the user.

11. The system of claim 7, wherein the intermediary communication system comprises one or more backend servers configured to cache communications when at least one of the recovery computing device and the rescuer computing device is offline.

12. The system of claim 7, wherein the cryptographic key is a symmetric encryption key and the secret sharing scheme is a Shamir Secret Sharing (SSS) scheme.

13. A method for recovering access to encrypted user credentials on a second user device, the method comprising:
establishing, by a first user device associated with a user, a rescue team comprising a plurality of rescuer devices, each associated with a trusted rescuer;
generating, by the first user device, a symmetric encryption key used to encrypt the user credentials;
splitting, by the first user device, the symmetric encryption key into a number of key shares using a Shamir Secret Sharing (SSS) scheme requiring a first threshold number of shares for reconstruction, where the first threshold number is less than or equal to a number of rescuer devices of the plurality of rescuer devices;
securely distributing one unique key share to each respective device of the plurality of rescuer devices, where each key share is different from one another;
receiving, at a backend server from the second user device, a recovery request associated with the user;
initiating, via the backend server, a recovery process involving at least the first threshold number of rescuer devices from the rescue team;
generating, on each rescuer device, a unique challenge for the user;
transmitting respective unique challenges from the respective rescuer device, via the backend server, to the second user device;
receiving, at each involved rescuer device via the backend server, challenge response from the second user device, where the challenge response is associated with each respective unique challenges;
verifying, by respective rescuers on the respective rescuer devices of the plurality of rescuer devices, the authenticity of the user based on the received challenge response;
encrypting, by the respective rescuer devices responsive to successful verification, its respective unique key shares using a public key associated with the second user device;
transmitting the respective unique key shares from the respective rescuer devices, via the backend server, to the second user device;
receiving, at the second user device, at least the first threshold number of encrypted key shares from different verifying rescuer devices;
decrypting, by the second user device, the received unique key shares;
reconstructing, by the second user device, the symmetric encryption key using the respective unique key shares of at least the first threshold number; and
decrypting the user credentials on the second user device using the reconstructed symmetric encryption key in order to recover data from the first user device to the second user device.

14. The method of claim 13, wherein the public key associated with the second user device is a temporary public key generated by the second user device specifically for the recovery process.

15. The method of claim 13, wherein the unique challenge comprises a prompt for the user to record a video, and wherein the challenge response comprises the recorded video.

16. The method of claim 13, wherein the challenge response received at the involved rescuer device is digitally signed using a private key associated with the second user device.

17. The method of claim 13, wherein generating the unique challenge on the rescuer device comprises receiving manual input from the respective rescuer defining the unique challenge.

18. The method of claim 13, further comprising transmitting, via the backend server, a notification of the recovery process initiation to the first user device, if the first user device is accessible, allowing the user of the first user device to halt the recovery process.
